(19) United States
(12) Patent Application Publication
(10) Pub. No.: US 2025/0191806 A1
(43) Pub. Date: Jun. 12, 2025

(54) INSULATED ELECTRIC WIRE, WIRING HARNESS, AND METHOD FOR PRODUCING INSULATED ELECTRIC WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yoshitaka YAMADA, Yokkaichi-shi (JP); Kyoma SAHASHI, Yokkaichi-shi (JP); Toyoki FURUKAWA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/845,822

(22) PCT Filed: Mar. 23, 2023
(86) PCT No.: PCT/JP2023/011349

§ 371 Date: Sep. 10, 2024

(30) Foreign Application Priority Data
Mar. 30, 2022 (JP) 2022-054995

(51) Int. Cl. H01B 7/08; H01B 7/00; H01B 13/06

(52) U.S. Cl. CPC H01B 7/08; H01B 13/06; H01B 7/0045

(57) ABSTRACT

An insulated electric wire includes flat portion and inverse flat portions. In the flat portion, a conductor has a flat shape that is long in a flat direction in a cross-section perpendicular to the axial direction. In the inverse flat portion, a conductor has a flat shape that is long in an inverse flat direction different from the flat direction in a cross-section perpendicular to the axial direction. In each cross-section, portions facing an conductor outer periphery include a first outer-peripheral region located in the flat direction with respect to the axial direction, and a second outer-peripheral region located in a direction perpendicular to the flat direction with respect to the axial direction, and the elemental wires in the first outer-peripheral region have deformation ratios deformed from a circular shape lower than the deformation ratios of the elemental wires in the second outer-peripheral region, the elemental wires composing the conductor.

### TECHNICAL FIELD

The present disclosure relates to an insulated electric wire, a wiring harness, and a method for producing an insulated electric wire.

### BACKGROUND ART

Flat cables including flat-shaped conductors are known. A flat cable can occupy a smaller space for installation than a generally used electric wire including a conductor having an approximately circular cross-section.

A conventional flat cable often includes a flat rectangular conductor as a conductor, as disclosed in Patent Documents 1 and 2. A flat rectangular conductor is a single metal wire formed to have a rectangular cross-section. Patent Documents 3 and 5, filed by the present applicants, each disclose an electric wire conductor including a strand that is formed by twisting a plurality of elemental wires together and is formed into a flat shape, from the viewpoint of achieving both flexibility and the space-saving properties. Patent Document 6 also discloses a flat-shaped conductor including a flat-shaped stranded wire conductor that is formed by twisting a plurality of elemental wires together.

### CITATION LIST

### Patent Literature

Patent Document 1: JP 2014-130739 A
Patent Document 2: JP 2019-149242 A
Patent Document 3: WO 2019/093309 A1
Patent Document 4: WO 2019/093310 A1
Patent Document 5: WO 2019/177016A1
Patent Document 6: JP 2020-191291 A

### SUMMARY OF INVENTION

### Technical Problem

As disclosed in Patent Documents 3 to 5, an insulated electric wire including a flat-shaped strand formed to have a flat shape as a conductor is excellent in both space-saving and flexibility. By utilizing the space-saving properties and flexibility in a height direction of the flat-shaped strand, the insulated electric wire including the flat-shaped strand can be suitably used for routing in various spaces such as a narrow space. Although it shows very high flexibility when bent in a height direction i.e., a flat direction of the flat shape, the flat-shaped strand, tends to show lower flexibility when bent in a width direction i.e., an edgewise direction of the flat shape than when bent in the height direction. When an insulated electric wire having the flat-shaped strand is used in an application involving complex bending, such as three-dimensional routing, bending in the height direction alone may not be sufficient to allow the complex bending required in a routing path.

In order to fully handle complex bending, it is necessary to bend the flat-shaped strand in a direction corresponding to the width direction, but as described above, it is more difficult to flexibly bend the flat-shaped strand in the width direction than in the height direction. Therefore, in the field of automotive electric wires, it is desired to develop an insulated electric wire that can flexibly handle complex bending such as three-dimensional routing while utilizing the space-saving properties of the flat-shaped strand. In particular, when the cross-sectional area of the conductor is increased in order to allow the insulated electric wire to handle larger currents, flexibility of the conductor tends to decrease; however, it is desirable that the insulated electric wire be able to undergo complex bending while also being space-saving even if an insulated electric wire has a large conductor cross-sectional area.

In view of the above, it is an object to provide an insulated electric wire having a conductor having a flat cross-section and flexibility sufficient to allow bending into a complex shape, a wiring harness including such an insulated electric wire, and a method for producing such an insulated electric wire.

### Solution to Problem

An insulated electric wire according to the present disclosure includes a conductor including a plurality of elemental wires twisted together, and an insulation covering that covers the conductor. The insulated electric wire includes a flat portion and an inverse flat portion along an axial direction of the insulated electric wire, wherein each of the elemental wires composing the conductor and the insulation covering are continuous between the flat portion and the inverse flat portion. In the flat portion, the conductor has a flat shape that is long in a flat direction in a cross-section perpendicular to the axial direction. In the inverse flat portion, the conductor has a flat shape that is long in an inverse flat direction different from the flat direction in a cross-section perpendicular to the axial direction, and in each of the cross-sections of both the flat portion and the inverse flat portion, portions facing an outer periphery of the conductor includes a first outer-peripheral region located in the flat direction with respect to the axial direction, and a second outer-peripheral region located in a direction perpendicular to the flat direction with respect to the axial direction, and the elemental wires in the first outer-peripheral region have deformation ratios from a circular shape lower than those of the elemental wires in the second outer-peripheral region.

A wiring harness of the present disclosure includes the insulated electric wire.

A method for producing an insulated electric wire according to the above-described insulated electric wire is produced by steps of preparing a raw flat electric wire including a conductor compressed into a flat shape, and an insulation covering that covers the conductor, deforming the conductor into a flat shape that is long in a direction different from the direction in which the flat shape of the conductor was long before the application of the force by applying a force to the raw flat electric wire from outside toward inside in a width direction of the flat shape in a partial region along the axial direction, thereby forming the inverse flat portion, and leaving a rest of the raw flat electric wire, where the inverse flat portion was not formed, as a flat portion, the region being other than that formed as the inverse flat portion, thereby producing the insulated electric wire according to any one of Claims 1 to 5.

### Advantageous Effects of Invention

The insulated electric wire, the wiring harness, and the method for producing an insulated electric wire according to the present disclosure is an insulated electric wire having a flat cross-section and flexibly bendable into a complex shape, a wiring harness including such an insulated electric wire, and a method for producing such an insulated electric wire.

### BRIEF DESCRIPTION OF DRAWINGS

FIG. 1 is a schematic perspective view showing an insulated electric wire according to an embodiment of the present disclosure.

FIG. 2 is a cross-sectional view showing a flat portion, which corresponds to cross-sections A-A and C-C in FIG. 1. In the main view, the elemental wires are omitted. Enlarged views enclosed in circles show regions R1 to R3 with the elemental wires.

FIG. 3 is a cross-sectional view showing an inverse flat portion, which corresponds to the cross-section B-B in FIG. 1. In the main view, the elemental wires are omitted. Enlarged views enclosed in circles show regions R1 to R3 with the elemental wires.

FIG. 4 is a diagram illustrating a method for producing an insulated electric wire according to an embodiment of the present disclosure, taking the insulated electric wire shown in FIG. 1 as an example.

FIGS. 5A to 5C show photographs of the cross sections of actual insulated electric wires, where FIG. 5A shows a flat electric wire, FIG. 5B shows an inverse flat electric wire with a flatness ratio of 1.8, and FIG. 5C shows an inverse flat electric wire with a flatness ratio of 2.8. The scales of the photographs are different from one another.

### DESCRIPTION OF EMBODIMENTS

### Description of Embodiments of Present Disclosure

An embodiment of the present disclosure will be described. An insulated electric wire includes a conductor including a plurality of elemental wires twisted together, and an insulation covering that covers the conductor, wherein the insulated electric wire includes a flat portion and an inverse flat portion along an axial direction of the insulated electric wire. Each of the elemental wires composing the conductor and the insulation covering are continuous between the flat portion and the inverse flat portion. In the flat portion, the conductor has a flat shape that is long in a flat direction in a cross-section perpendicular to the axial direction. In the inverse flat portion, the conductor has a flat shape that is long in an inverse flat direction different from the flat direction in a cross-section perpendicular to the axial direction, and in each of the cross-sections of both the flat portion and the inverse flat portion, portions facing an outer periphery of the conductor includes a first outer-peripheral region located in the flat direction with respect to the axial direction, and a second outer-peripheral region located in a direction perpendicular to the flat direction with respect to the axial direction, and the elemental wires in the first outer-peripheral region have deformation ratios from a circular shape lower than those of the elemental wires in the second outer-peripheral region.

The insulated electric wire has the conductor including a flat portion and an inverse flat portion, each of which has a flat shape, and exhibits high space-saving properties. Further, the flat portion and the inverse flat portion exhibit high bending flexibility in the height direction of their respective flat shapes. The width directions of the flat shapes of the flat portion and the inverse flat portion are oriented in mutually different directions, that is, a flat direction and an inverse flat direction, respectively, so that the insulated electric wire exhibits high bending flexibility in different directions at both portions. If the flat portion and the inverse flat portion are arranged in the insulated electric wire so that each height direction is oriented in a direction in which bending is desired at each portion of the flat portion and the inverse flat portion, it is possible to bend easily different portions of a single insulated electric wire in different directions along an axial direction of the insulated electric wire and to bend flexibly the insulated electric wire into a complex shape such as for a three-dimensional routing. In this way, the insulated electric wire can achieve both space-saving due to the flat shape and high flexibility in bending. Such an insulated electric wire can be suitably used in areas where space is limited, or where routing into a complicated path is required, such as inside an automobile.

The insulated electric wire in which the flat portion and the inverse flat portion coexist as described above can be easily produced by preparing a raw flat electric wire including a conductor compressed into a simple flat shape, compressing the raw flat electric wire in a certain portion along the axial direction from the width direction to form the inverse flat portion having a flat shape oriented in a different direction from that of the raw flat electric wire, and leaving the other portion as the flat portion. In the raw flat electric wire, deformation of the elemental wires is often smaller in an outer region in the width direction than in an outer region in a height direction, since the conductor is produced by compression into a flat shape. In this case, when the inverse flat portion is formed by the above-mentioned production method, the insulated electric wire is likely to have the flat portion and the inverse flat portion each of which has a state in which the elemental wires composing the conductor in the first outer-peripheral region are more likely to have a lower deformation ratios from a circular shape than that in the second outer-peripheral region, with the first outer-peripheral region corresponding to the region on an outer region in the width direction of the raw flat electric wire, and the second outer-peripheral region corresponding to the region in the height direction of the raw flat electric wire, the elemental wires composing the conductor. Furthermore, the fact that the elemental wires have lower deformation ratios in the first outer-peripheral region than in the second outer-peripheral region means that no significant deformation has been caused to each of the elemental wires when the inverse flat portion is formed in the raw flat electric wire. In other words, the fact serves as an indicator showing that significant change, such as hardening due to deformation of the elemental wires or an increase in electrical resistance, have not occurred when the inverse flat portion is formed.

Here, the elemental wires in the first outer-peripheral region preferably have lower deformation ratios from a circular shape than in a central portion of the conductor in the cross-sections of both the flat portion and the inverse flat portion. When the insulated electric wire in which the flat portion and the inverse flat portion coexist is produced, using the raw flat electric wire having the flat-shaped conductor as described above, the elemental wires in the first outer-peripheral region of the conductor tend to undergo smaller deformation than those in the central region in both the flat portion and the inverse flat portion.

The flat direction and the inverse flat direction preferably differ by 10° or more. The flat direction and the inverse flat direction preferably differ by 45° or more. In this case, flexibly bendable directions between the flat portion and the inverse flat portion differ by 10° or more and 45° or more, and the insulated electric wire can be particularly suitably used in applications in which the insulated electric wire is bent into a complex shape, such as a three-dimensional shape for routing.

In each of the cross-sections of both the flat portion and the inverse flat portion, the elemental wires in the first outer-peripheral region preferably have the deformation ratios from a circular shape of 70% or lower of those in the second outer-peripheral region. The fact that the elemental wires in the first outer-peripheral region have lower deformation ratios means that the elemental wires themselves are not significantly deformed by application of a force for forming the inverse flat portion when the insulated electric wire in which the flat portion and the inverse flat portion coexist is produced, from the raw flat electric wire having the flat-shaped conductor as described above, thereby serving as an indicator for suppression of changes such as hardening and an increase in electrical resistance due to deformation of the elemental wires.

A wiring harness according to the present disclosure includes the above-mentioned insulated electric wire. As described above, the insulated electric wire according to the present disclosure has the flat portion and the inverse flat portion, exhibiting high bending flexibility in respective height directions, and therefore, the wiring harness can be suitably used in applications that require bending of the insulated electric wire into a complex shape, such as three-dimensional routing.

A method for producing the insulated electric wire according to the present disclosure is produced by steps of preparing the raw flat electric wire including the conductor compressed into a flat shape, and an insulation covering that covers the conductor, deforming the conductor into a flat shape that is long in a direction different from the direction in which the flat shape of the conductor was long before the application of the force, by applying a force to the raw flat electric wire from outside toward inside in a width direction of the flat shape in a partial region along the axial direction, thereby forming the inverse flat portion and leaving a region as the flat portion in the raw flat electric wire, the region being other than that formed as the inverse flat portion, thereby producing the insulated electric wire.

By the production method, the insulated electric wire according to the embodiment of the present disclosure in which the flat portion and the inverse flat portion coexist can be easily produced using the raw flat electric wire having the conductor with a simple flat shape. For the raw flat electric wire, the position and length of the inverse flat portion, as well as specific inverse flat direction and flatness ratio can be arbitrarily set according to a location of routing of the insulated electric wire. Accordingly, it is possible to produce the insulated electric wire that can be bent and arranged in a variety of spaces into a variety of shapes, using a common raw flat electric wires.

### Detailed Description of Embodiments of Present Disclosure

Hereinafter, a detailed description of an insulated electric wire, a wiring harness and a method for producing an insulated electric wire according to embodiments of the present disclosure will be provided in detail with reference to the drawings. In the present specification, the terms indicating the shapes and arrangements of members, such as “straight”, “parallel”, and “perpendicular”, regarding parts of the insulated electric wire, include deviations from the geometric concepts, within an acceptable range for this type of insulated electric wire, such as approximately ±15% in length and approximately ±15° in angle. In the present specification, the cross-sections of the insulated electric wire and the conductor refer to cross-sections cut perpendicular to the axial direction (i.e., longitudinal direction) thereof unless otherwise specified.

### Overall Structure of Insulated Electric Wire

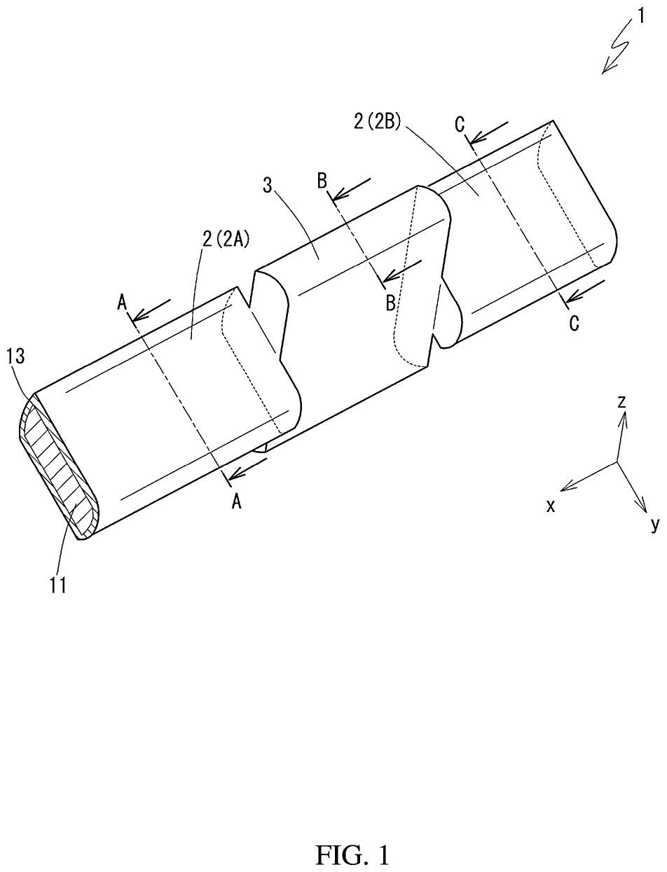

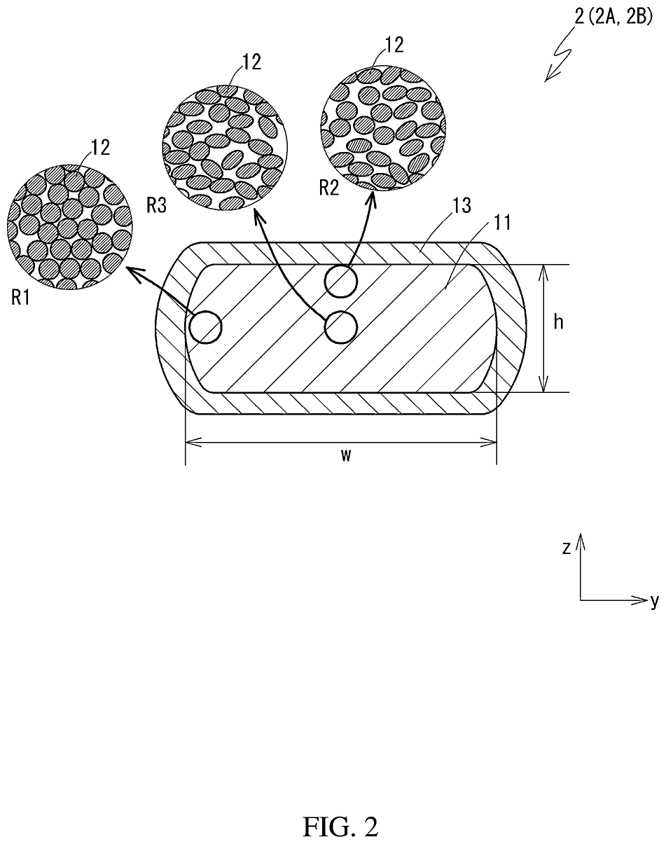

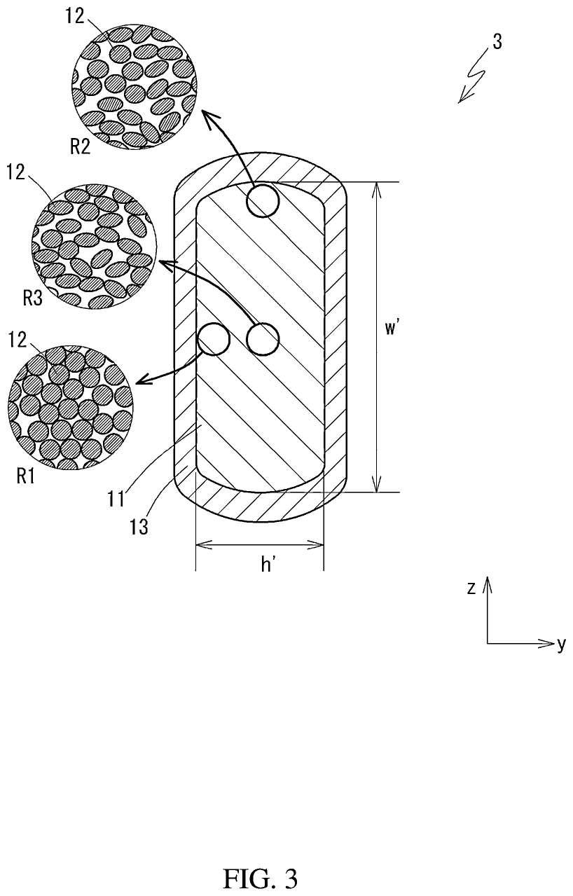

FIG. 1 is a schematic perspective view showing an insulated electric wire 1 according to an embodiment of the present disclosure. FIG. 2 is a view showing a cross-section taken along lines A-A and C-C in FIG. 1. FIG. 3 is a view showing a cross-section taken along line B-B in FIG. 1. In FIG. 1, and main views of FIGS. 2 and 3, illustrations of elemental wires are omitted for simplification. States of the elemental wires in each portion is shown in circled regions in FIGS. 2 and 3.

The insulated electric wire 1 according to the present embodiment includes a conductor 11 and an insulation covering 13. The conductor 11 is formed as a strand including a plurality of elemental wires 12 twisted together. The insulation covering 13 covers an entire outer periphery of the conductor 11. The insulated electric wire 1 has a flat portion 2 (2A and 2B) and an inverse flat portion 3 along an axial direction (x-direction). The flat portion 2 and the inverse flat portion 3 are continuous along the axial direction of the insulated electric wire 1. In other words, the elemental wires 12 composing the conductor 11 are continuous between the flat portion 2 and the inverse flat portion 3. Furthermore, the insulation covering 13 that covers the conductor 11 is also continuous between the flat portion 2 and the inverse flat portion 3.

In the flat portion 2 and the inverse flat portion 3, the conductor 11 has a cross-section having a flat outer shape. Here, the term “flat outer shape” with respect to the conductor 11 indicates a shape where the width (“w” in the flat portion 2 and “w′” in the inverse flat portion 3) is longer than the height (“h” in the flat portion 2 and “h′” in the inverse flat portion 3). The width indicates the length of the longest straight line that crosses the cross-section of the conductor in a direction along an edge or diameter constituting the cross-section and ranges over the entire cross-section, while the height indicates the length of the straight line that is perpendicular to the above-mentioned straight line defining the width and ranges over the entire cross-section. In each of the flat portion 2 and the inverse flat portion 3, the cross-section of the conductor 11 may have any specific shape as long as it is flat. In an embodiment shown in the figures, the cross-section of the conductor 11 has a shape that can be approximated to a rectangle in both the flat portion 2 and the inverse flat portion 3. An example of a flat shape other than a rectangle includes an ellipse, an oblong, and an oval shape (i.e., a rectangle with arcs at both ends).

The conductor 11 has a flat outer shape in the cross-section in both the flat portion 2 and the inverse flat portion 3; however, a width direction of the flat outer shape is different between the flat portion 2 and the inverse flat portion 3. In other words, where the width direction of the flat portion 2 (a direction in which the width “w” extends) is defined as a flat direction, and the width direction of the inverse flat portion 3 (a direction in which the width “w′” extends) is defined as an inverse flat direction, the inverse flat direction is oriented in a direction different from the flat direction. The difference between the flat direction and the inverse flat direction is not particularly limited; however, a case where the difference is 90° will be given hereinafter as an example. In the figures, the flat direction is indicated by y-direction, and the inverse flat direction is indicated by z-direction. The arrangements of the flat portion 2 and the inverse flat portion 3 within the insulated electric wire 1 are not particularly limited; however, in the embodiment shown in the figures, a first flat portion 2A, the inverse flat portion 3, and a second flat portion 2B are arranged adjacent to each other in this order along the axial direction (x-direction) of the insulated electric wire 1. The flat portion 2 and the inverse flat portion 3 are directly adjacent to each other, except for regions which are inevitably created in between due to abrupt changes in the direction of the cross-sectional shape.

As illustrated in FIG. 2, in the cross-section of the flat portion 2, the conductor 11 and the insulated electric wire 1 as a whole have flat outer shapes elongated in the y-direction (flat direction). Meanwhile, as illustrated in FIG. 3, in the cross-section of the inverse flat portion 3, the outer shape of the conductor 11 and the insulated electric wire 1 as a whole are flat shapes elongated in the z-direction (inverse flat direction). In the flat portion 2 and the inverse flat portion 3, at least some of the elemental wires 12 composing the conductor 11 have cross-sections that are deformed from a circular shape and their deformation ratios have a specific spacial distribution. States of deformation of the elemental wires 12 will be described in detail later.

The insulated electric wire 1 does not exhibit very high flexibility in the width direction of each of the flat shapes in the flat portion 2 and the inverse flat portion 3. Therefore, the insulated electric wire 1 can not be easily bent in the width direction. Meanwhile the insulated electric wire 1 exhibits very high flexibility in the height direction. Therefore, the insulated electric wire 1 can easily bent in the height direction. That is, it is difficult to bend the flat portion 2 in the y-direction but easy to bend in the z-direction, whereas it is difficult to bend the inverse flat portion 3 in the z-direction but easy to bend in the y-direction.

In this way, the flat portion 2 and the inverse flat portion 3 exhibit anisotropy in terms of flexibility in different directions, and since the flat portion 2 and the inverse flat portion 3 coexist within a single insulated electric wire 1, the direction in which the insulated electric wire 1 is easily bent varies depending on a position. That is, the insulated electric wire 1 can be easily bent in a direction in which the height direction of the position is oriented. By bending the insulated electric wire 1 in the direction corresponding to the height direction at each portion, the insulated electric wire 1 as a whole can be bent into a complex shape. Meanwhile, since it is difficult to bend each portion in the width direction, bending in an undesired direction can be restricted, and wrenching of the insulated electric wire 1 is unlikely to occur. By utilizing the anisotropy in bending flexibility of each of these portions, the insulated electric wire 1 can be suitably used in applications that require bending into a complex shape, such as three-dimensional routing or routing along an object with a complex shape. For example, in the embodiment shown in the figures, the insulated electric wire 1 can be bent in the z-direction at the first flat portion 2A, bent in the y-direction at the adjacent inverse flat portion 3, and then bent again in the z-direction at the second flat portion 2B, thereby allowing easy formation of a complex shape of bending, where the directions are based on the state shown in the figures.

As described in the foregoing, in the insulated electric wire 1 according to the present embodiment, the flat portion 2 and the inverse flat portion 3 have flat shapes, respectively, thereby achieving high space-saving in the height direction of each portion. At the same time, the flat portion and the inverse flat portion have flat shapes having different orientations of the width directions from each other, the insulated electric wire 1 as a whole can be bent flexibly into complex shapes. The applications of the insulated electric wire 1 are not specifically limited; however, the insulated electric wire 1 can be suitably used for routing inside an automobile, where the space in which the insulated electric wire 1 can be routed is limited and where the insulated electric wire 1 is frequently bent into complex shapes.

In the embodiment described above, the inverse flat portion 3 is provided between the two flat portions 2A and 2B; however, a number and arrangement of the flat portion(s) 2 and the inverse flat portion (3) 3 are not particularly limited, and a required number of the flat portions 2 and the inverse flat portions 3, each having the height direction of the flat shape oriented in the direction to be bent, may be formed at a position where bend is to be formed in the insulated electric wire 1, depending on the specific wiring route assumed for each insulated electric wire 1. Further, the two flat portions 2A, and 2B are formed to have an identical flatness ratio w/h here; however, when a plurality of the flat portions 2 are formed and/or a plurality of the inverse flat portions 3 are formed, each of the plurality of the flat portions 2 and the plurality of the inverse flat portions 3 may have an identical flatness ratio as each other or may have different flatness ratios from each other. Here, the flatness ratio is a value indicating a ratio of a width to a height of the flat shape in the cross-section of each portion (w/h for the flat portion 2 and w′/h′ for the inverse flat portion 3).

The flatness ratio (w/h or w′/h′) of a flat shape between the flat portion 2 and the inverse flat portion 3 may be identical or different from each other. The higher the flatness ratio is, the greater the bending flexibility in the height direction is. Thus, the flatness ratio of each portion can be determined according to a degree of flexibility required. From the viewpoint of ensuring similar flexibility in each portion of the insulated electric wire 1, the inverse flat portion 3 preferably has the flatness ratio w′/h′ within a range of approximately 0.5 to 2.0 times the flatness ratio w/h of the flat portion 2, more preferably within a range of approximately 0.8 to 1.2 times. From the viewpoint of sufficiently increasing flexibility in the height direction, the flatness ratio w/h of the flat portion 2 and the flatness ratio w′/h′ of the inverse flat portion 3 are preferably 1.5 or higher, and more preferably 2.0 or higher, while they are preferably 6.0 or lower from the viewpoint of preventing excessive deformation of the elemental wires 12 described later.

In the embodiment described here, a difference in angle between the width directions of the flat portion 2 and the inverse flat portion 3, i.e., a difference between the flat direction and the inverse flat direction, is set to 90°; however, the specific angle difference is not particularly limited as long as they have different directions. In each portion of the insulated electric wire 1, an angle to be oriented in the width direction of the flat portion 2 and the inverse flat portion 3 may be appropriately determined depending on a direction in which the insulated electric wire 1 is to be bent. For example, if a difference in angle in the width direction between the adjacent flat portion 2 and the inverted flat portion 3 is set to 10° or more, an enhanced effect of realizing bending in various directions can be sufficiently obtained by the insulated electric wire 1 provided with the flat portion 2 and the inverted flat portion 3. The greater the difference in angle in the width direction between the flat portion 2 and the inverse flat portion 3, the easier the insulated electric wire is bent into a complex shape. For example, the difference is preferably set to 45° or more, and particularly preferably 80° or more.

In the foregoing, a description was made for an embodiment in which the flat portion 2 oriented in one width direction (y-direction) and the inverse flat portion 3 oriented in another width direction (z-direction) coexist in a single insulated electric wire 1; however, three or more types of portions may coexist, with the portions oriented in three or more different width directions. In other words, in the insulated electric wire 1, when any region having a flat cross-sectional shape is designated as the flat portion 2, as long as at least one inverse flat portion 3 is formed with the width direction oriented in a different direction from that of the flat portion 2, it is possible to freely design the angle at which the width direction of the flat is oriented, the flatness ratio, or the position and length in the axial direction in each part of the insulated electric wire 1, thereby forming a plurality of portions. Further, the insulated electric wire 1 may have the conductor 11 provided with a region where the cross-sectional shape of the conductor 11 is not flat, a circle or a square, for example, in addition to a region where the cross-sectional shape of the conductor 11 is flat. As examples of embodiments in which the non-flat portion can be provided, ends of the insulated electric wire 1, a position separating the plurality of the flat portions 2 from each other, a position separating the plurality of the inverse flat portions 3 from each other, and a position separating the flat portion 2 and the inverse flat portion 3 may be included. However, from the viewpoint of ensuring high space-saving and flexibility over an entire area of the insulated electric wire 1, the non-flat portion is preferably not to be provided.

In the insulated electric wire 1 according to the present embodiment, the material, a wire diameter, and a conductor cross-sectional area of the elemental wires constituting the conductor 11 are not particularly limited. However, the conductor 11 having a relatively large conductor cross-sectional area is preferably used from the viewpoint of enhancing the effect of improving bending flexibility to each direction by forming the flat portion 2 and the inverse flat portion 3. From this viewpoint, preferable materials for use in constituting the conductor 11 include aluminum and aluminum alloys, which have lower electrical conductivities than copper and copper alloys and therefore often made to have larger conductor cross-sectional areas. The conductor cross-sectional area is preferably 10 mm² or larger, more preferably 50 mm² or larger, or even more preferably 100 mm² or larger. The outer diameter of the elemental wires 12 constituting the conductor 11 can be, for example, 0.1 mm or larger and 1.0 mm or smaller.

The insulated electric wire 1 according to the present embodiment may be used alone or as a member for constituting a wiring harness according to an embodiment of the present disclosure. The wiring harness according to the embodiment of the present disclosure includes the insulated electric wire 1 according to the above-described embodiment. The wiring harness may include a plurality of the insulated electric wire 1 or may include other types of insulated electric wires in addition to the insulated electric wire 1.

### Production Method for Insulated Electric Wire

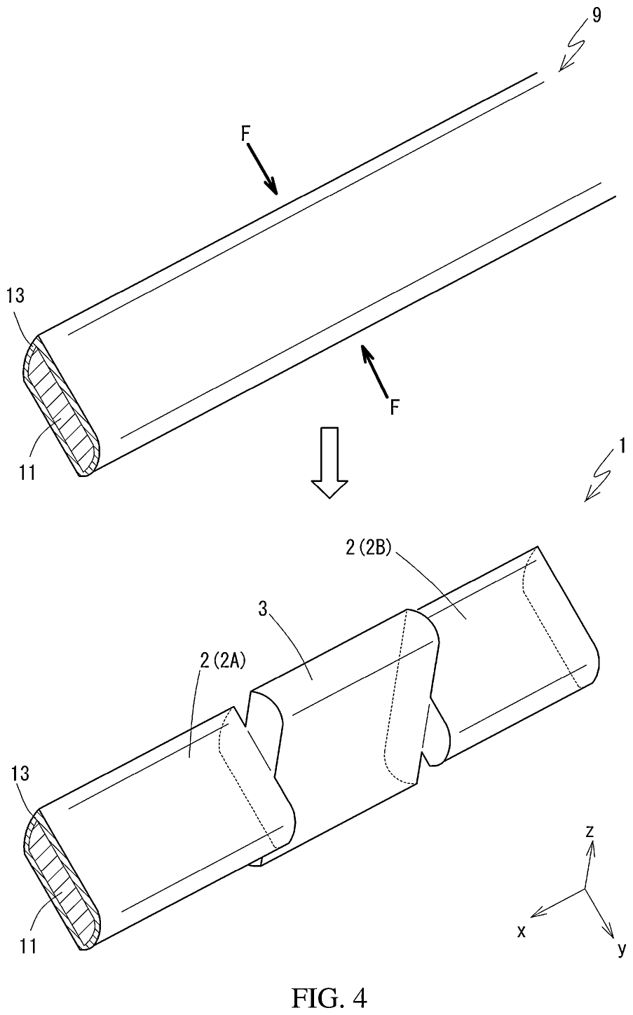

Here, a method for producing an insulated electric wire 1 of the present embodiment will be described. FIG. 4 is a schematic view showing a method for producing the insulated electric wire 1.

The insulated electric wire 1 according to the present embodiment may be formed by using a raw flat electric wire 9. The raw flat electric wire 9 is an electric wire including a conductor 11 compressed into a flat shape and an insulation covering 13 that covers the outer periphery of the conductor 11. In the raw flat electric wire 9, the entire portion is formed in a uniform flat shape, having the cross-section oriented in an identical width direction along the axial direction and having a flat shape with a same flatness ratio. The raw flat electric wire 9 can be produced by compressing the conductor 11 that is composed of a plurality of the elemental wires twisted together and having a circular cross-section, into a flat shape, and covering the outer periphery of a conductor 11 with the insulation coating 13. At this time, the conductor 11 can be suitably compressed from both sides in the height direction and, optionally, from both sides in the width direction, using rollers, as described in Patent Documents 3 to 5. The insulation covering 13 may be formed around the outer periphery of the conductor 11 subjected to compression, preferably by extrusion molding of a resin composition. From the viewpoint of deforming the conductor 11 to have a sufficiently flat shape, it is preferable to form the insulation covering 13 after the conductor 11 is deformed into a flat shape as described above; however, the raw flat electric wire 9 may be formed by compressing a conventional round electric wire in which the insulation covering 13 is formed around the outer periphery of the conductor 11 having an approximately circular cross-section, entirely with the insulation covering 13 into a flat shape.

Then, a force F is applied to the above-obtained raw flat electric wire 9 from outside of the raw flat electric wire 9 in a partial region along the axial direction. More specifically, the force F is applied to a region where the inverse flat portion 3 is to be formed. By the application of the force F, the conductor 11 is deformed. Here, the force F is applied from outside toward inside along the width direction (y-direction) of the flat shape. The force F is applied until the width direction of the flat shape of the conductor 11 changes from the original direction, and the conductor 11 is deformed into a flat shape that is long in a direction different from the direction in which the flat shape of the conductor 11 was long before application of the force F. The inverse flat portion 3 can be formed by this operation. When the inverse flat portion 3 is formed, a force may be applied from any direction as appropriate in order to orient the inverse flat direction in a specific direction, in addition to application of the force F along the width direction. Then, a rest of the raw flat electric wire 9, where the inverse flat portion was not formed as described above, is left as the flat portion 2. For producing the insulated electric wire 1 having a structure shown in FIG. 1, the width direction of the raw flat electric wire 9 is oriented in the y-direction, and the force F is applied from outside toward inside along the width direction (y-direction) in a middle portion of the raw flat electric wire 9 in the axial direction to deform the cross-sectional shape from a horizontally elongated state to a vertically elongated state, thereby forming the inverse flat portion 3. Meanwhile, in the portions on both sides of the inverse flat portion 3 in the axial direction, the horizontally elongated flat shape of the raw flat electric wire 9 is left unchanged, thereby forming two flat portions 2A and 2B.

Application of the force F to form the inverse flat portion 3 can be performed by manual processing or processing using a tool such as a hammer, or a device such as a molding die or a press. Here, the force F applied to the conductor 11 is preferably smaller than a force applied to flatten the conductor 11 when the raw flat electric wire 9 is formed. Furthermore, during or after formation of the inverse flat portion 3 by application of the force F, the insulation covering 13 may be optionally heated in a portion including the inverse flat portion 3 to make the insulation covering 13 adhere to the conductor 11. Furthermore, the application of the force F for forming the inverse flat portion 3 may cause the insulation covering 13 to be thinner than the flat portion 2 in the direction in which the force F is applied, i.e., above and below in the height direction of the inverse flat portion 3. However, a thickness of the insulation covering 13 at each portion of the inverse flat portion 3 is preferably at least 20% or more, and more preferably at least 40% or more, of the thickness of the insulation covering 13 in the flat portion 2.

As described in the foregoing, in the insulated electric wire 1 according to the present embodiment, the inverse flat portion 3 can be formed by simply applying the force F that deforms the conductor 11 to the raw flat electric wire 9 from outside the insulation covering 13. Therefore, it is possible to produce various insulated electric wires 1, having different positions where the inverse flat portion 3 is required, as well as different directions and degrees of flatness of the inverse flat portion 3 required, using a common raw flat electric wire 9. In this manner, it is possible to easily produce the insulated electric wire 1 that can be flexibly deformed into various complex shapes according to a specific wiring route of the insulated electric wire 1. Here, a description has been made mainly as to an embodiment in which only one type of the flat portion 2 and one type of the inverse flat portion 3 coexist. However, even when forming an insulated electric wire having three or more types of portions with different width directions oriented and/or flatness ratio of the flat shape, at least one of the portions may be formed by leaving the original flat shape of the raw flat electric wire 9, and the remaining portions may be formed by applying forces to the raw flat electric wire 9 to deform it to have desired directions and flatness ratios.

### Distribution of Deformation Ratios of Elemental Wires

In the insulated electric wire 1 according to the present embodiment, deformation ratios of the cross-sectional shapes of the elemental wires 12 are distributed non-uniformly, related such as to the production method described above. Here, deformation ratio of a certain elemental wire 12 is an index indicating how much a cross-sectional shape of the certain elemental wire 12 deviates from a circular shape. For a certain elemental wire 12 actually included in the conductor 11, the deformation ratio D of the certain elemental wire 12 can be expressed as following formula (1).

D=(A−R)/R×100% (1)

where the length of the longest straight line crossing the cross-section of the elemental wire 12 is defined as a long diameter A and the diameter of a circle having an identical area as the cross-sectional area of the elemental wire 12 is defined as a circular diameter R. For evaluating the deformation ratios of the elemental wires 12 in specific portions in the cross-sections of the conductor 11, it is preferable to estimate the deformation ratios as average values for a plurality of the elemental wires 12 included in regions having certain areas, such as the regions R1 to R3 shown in FIGS. 2 and 3, from the viewpoint of reducing influences in variations in the deformation of the elemental wires 12. For example, a region may be set as an area surrounded by a rectangle having sides with a length of approximately 10% to 30% of the widths w, or w′ of the conductor 11 or a circle having a diameter of such a length, a circle or an ellipse.

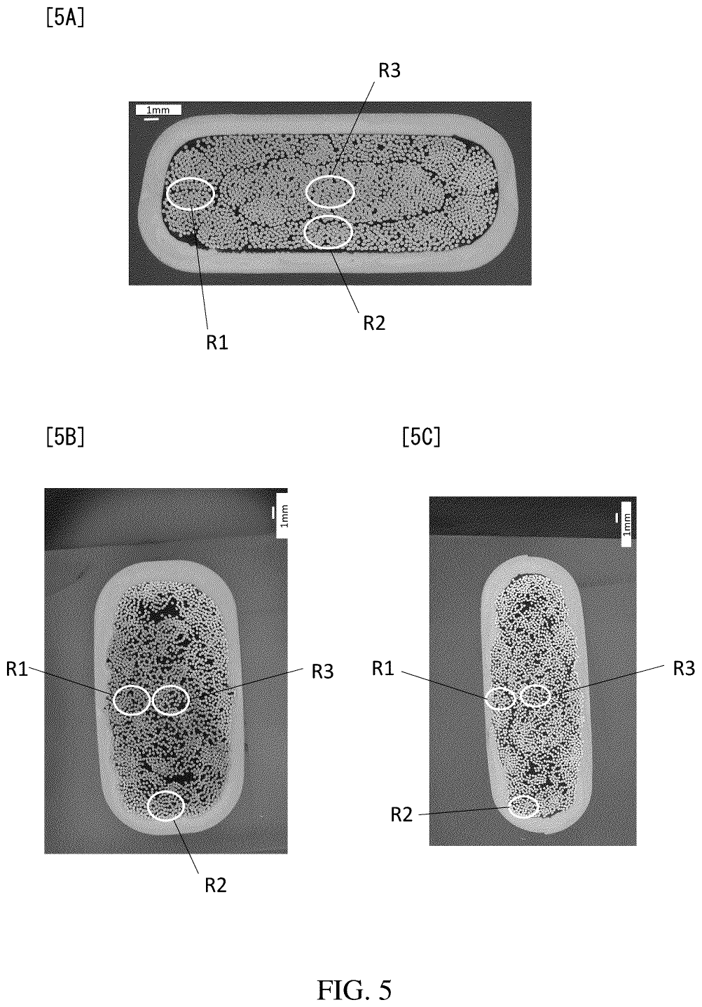

In the insulated electric wire 1 according to the present embodiment, in each of the cross-sections of both the flat portion 2 and the inverse flat portion 3, the elemental wires 12 in a first outer-peripheral region R1 have lower deformation ratios from a circular shape than that in a second outer-peripheral region R2. Facing an outer periphery of the conductor 11, the first outer peripheral region R1 located in the flat direction (width direction of the flat portion 2) with respect to the axial direction of the insulated electric wire 1, while the second outer-peripheral region R2 located in the direction perpendicular to the flat direction with respect to the axial direction (height direction of the flat portion 2) among (outer-peripheral) portions. The illustrated embodiment shows that, in each of the two flat portions 2 and the inverse flat portion 3, the elemental wires 12 have lower deformation ratios from a circular shape in the first outer-peripheral region R1 located in y-direction than those in the second outer-peripheral region R2 located in z-direction, among the portions facing the outer periphery of the conductor 11. In other words, in both the flat portion 2 and the inverse flat portion 3, the elemental wires 12 in the first outer-peripheral region R1 have shapes closer to a circular shape than the elemental wires 12 in the second outer-peripheral region R2. In FIGS. 2 and 3, though deformation of each elemental wire 12 is shown schematically, and each elemental wire 12 in the second outer-peripheral region R2 is shown deformed into a flat elliptical shape, in an actual conductor 11, the elemental wires may not only be deformed into such flat shapes but may also be deformed into irregular shapes, such as the elemental wires included in the cross-sectional images of FIGS. 5A to 5C.

Furthermore, in each of the cross-sections of both the flat portion 2 and the inverse flat portion 3 of the insulated electric wire 1 according to the present embodiment, the elemental wires 12 in the first outer-peripheral region R1 have lower deformation ratios from a circular shape than not only those in the second outer-peripheral region R2 but also those in a central region R3 located in a central portion of the conductor 11. Here, the central portion of the conductor 11 refers to a region located inside the outer periphery of the conductor 11. The relationship in the deformation ratios of the elemental wires 12 between the second outer-peripheral region R2 and the central region R3 are not particularly limited.

As described above, when the insulated electric wire 1 according to the present embodiment is formed from the raw flat electric wire 9 including a flat-shaped stranded conductor, the conductor 11 included in the raw flat electric wire 9 has been deformed into a flat shape by application of a gentle force to the strand using the rollers. As a result, as described in Patent Documents 3 to 5, the elemental wires 12 have lower deformation ratios at widthwise ends than at heightwise ends and the central portion, among the outer periphery of the flat shaped conductor 11. When the insulated electric wire 1 according to the present embodiment is produced from the raw flat electric wire 9 is produced, a structure of the conductor 11 in the raw flat electric wire 9 is substantially carried over unchanged to the flat portion 2. Though, in the inverse flat portion 3, the overall external shape of the conductor 11 is deformed into a flat shape in a direction different from the raw flat electric wire 9, the deformation does not significantly affect the shape of each of the elemental wires 12 and the shape of each of the elemental wires 12 is hardly changed or only slightly changed. Therefore, the distribution of the deformation ratios of the elemental wires 12 in the raw flat electric wire 9 is carried over almost unchanged to the inverse flat portion 3. As a result, in the flat portion 2 and the inverse flat portion 3 of the insulated electric wire 1 according to the present embodiment, the elemental wires 12 have lower deformation ratios in areas in the direction which were the widthwise ends of the raw flat electric wire 9, i.e., in the areas in the width direction of the flat portion 2 (y-direction in the figure) than in areas in the direction perpendicular thereto, i.e., in the areas in the height direction of the flat portion 2 (z-direction in the figure), and further, than in the central portion. If a round electric wire having a conductor with an approximately circular cross-section is used as a raw material, and the conductor is deformed to form a flat portion and an inverse flat portion having different directions of flat shapes, by application of the forces in different directions depending on the portions in the axial direction, the elemental wires 12 in both the flat portion and the inverse flat portion have lower deformation ratios at the outer portions in the width direction than at the outer portions in the height direction and at the central portion, among the outer peripheral portions.

In the flat portion 2 and the inverse flat portion 3, a rate of the deformation ratios of the elemental wires 12 in the first outer-peripheral region R1 to the deformation ratios of the elemental wires 12 in the second outer-peripheral region R2 are not particularly limited; however, the elemental wires 12 in the first outer-peripheral region R1 preferably have deformation ratios as low as possible. For example, it is preferable that the rate of the deformation ratios of the elemental wires 12 in the first outer-peripheral region R1 to the deformation ratios of the elemental wires 12 in the second outer-peripheral region R2 (deformation ratio first outer-peripheral region R1/deformation ratio in second outer-peripheral region R2×100%) is 70% or lower, and more preferably 65% or lower, in both the flat portion 2 and the inverse flat portion 3. Furthermore, the rate of the deformation ratios of the elemental wires 12 in the first outer-peripheral region R1 to the deformation ratios of the elemental wires 12 in the central region R3 (deformation ratio in the first outer-peripheral region R1/deformation ratio in the central region R3×100%) is preferably 80% or lower, and further preferably 70% or lower, in both the flat portion 2 and the inverse flat portion 3. The lower the deformation ratios of the elemental wires 12 in the first outer-peripheral region R1, the more preferable it is, and therefore, no lower limit is particularly set for these ratios.

When the deformation ratios of the elemental wires 12 are compared in respective regions R1 to R3 between the flat portion 2 and the inverse flat portion 3, the relationship of the deformation ratios between the portions is not specifically limited. In the first outer-peripheral region R1, the deformation ratios of the elemental wires 12 are likely to be larger in the inverse flat portion 3 than in the flat portion 2, due to application of the force F when the inverse flat portion 3 is formed. However, it is preferable to suppress the deformation ratios of the elemental wires 12 in the first outer-peripheral region R1 in the inverse flat portion 3 to three times or lower, and more preferably two times or lower than in the flat portion 2. The deformation ratios of the elemental wires 12 in the second outer-peripheral region R2 and the central region R3 are unlikely to change significantly even after application of the force F to form the inverse flat portion 3, and in these regions R2 and R3, the deformation ratios of the elemental wires 12 in the inverse flat portion 3 are preferably within a range of ±20% with respect to the deformation ratios in the flat portion 2.

Absolute values of the deformation ratios of the elemental wires 12 are not particularly specified in the regions R1 to R3; however, from the viewpoint of avoiding excessive load to be applied to the elemental wires 12, the deformation ratios in the first outer-peripheral region R1 are preferably 15% or lower, or more preferably 12% or lower, and the deformation ratios in the second outer-peripheral region R2 and the central region R3 are preferably 25% or lower, or more preferably 20% or less, in both the flat portion 2 and the inverse flat portion 3, for example. However, from the viewpoint of forming a flat shape efficiently, the deformation ratios of the elemental wires 12 in the second outer-peripheral region R2 and the central region R3 are preferably 5% or more, and more preferably 10% or more.

As described above, the reason of the lower deformation ratios of the elemental wires 12 in the first outer-peripheral region R1 in both the flat portion 2 and the inverse flat portion 3 is related to the production method of the insulated electric wire 1 using the raw flat electric wire 9 as a raw material; however, the fact that the lower deformation ratios of the elemental wires 12 in the first outer-peripheral region R1 also serve as an index showing that the elemental wires themselves are not significantly deformed in the entire conductor 11 including the first outer-peripheral region R1 due to application of the force F to form the inverse flat portion 3. Since large loads are not applied to the elemental wires 12, the elemental wires 12 are less likely to undergo changes such as hardening (work hardening) due to deformation or an increase in electrical resistance. As a result, the properties of the insulated electric wires 12 used as the raw material can be utilized in the insulated electric wire 1 in which the flat portion 2 and the inverse flat portion 3 coexist without being significantly changed.

Here description has been made as to an embodiment in which only one type of the flat portion 2 and one type of the inverse flat portion 3 coexist; however, even when an insulated electric wire is formed to have three or more types of portions with different width directions and/or flatness ratios of flat shapes, the distribution of the deformation ratios of the elemental wires 12 is as described above in each cross-section of the three or more types of portions. In other words, when at least one of the three or more types of portions is defined as a flat portion 2, and the region located in the flat direction of the flat portion 2 is defined as the first outer-peripheral region R1 among the regions facing the outer periphery of the conductor 11, while the region located in a direction perpendicular to the flat direction is defined as a second outer-peripheral region R2, the deformation ratios of the elemental wires 12 are lower in the first outer peripheral region R1 than in the second outer-peripheral region R2, in the cross-sections of all the three or more types of portions included in the insulated electric wire. In other words, the elemental wires in a region located in an identical direction with respect to the axial direction have lower deformation ratios than the elemental wires in a region located in a direction perpendicular to that region, over the entire length of the insulated electric wire. The detailed relationship between the deformation ratios of the elemental wires 12 at each of the three or more portions preferably as described above.

### EXAMPLE

Examples will be shown below. The present invention is not limited to these examples. Here, distributions of deformation ratios and bending flexibilities of elemental wires in a flat portion and an inverse flat portion were studied.

### Preparation of Samples

A flat electric wire was prepared. First, a strand with a circular cross-section was prepared by twisting a plurality of elemental wires made of an aluminum alloy. The strand was rolled into a flat shape using rollers to produce a conductor. The strand used had a conductor cross-sectional area of 130 mm² and a diameter of an elemental wire of 0.26 mm. A flatness ratio of the flat shape was set to 3. Then, an outer periphery of the prepared conductor, an insulation covering was formed by extrusion molding. As a constituent material of the insulation covering, cross-linked polyethylene was used. This flat electric wire was prepared as a model of the flat portion included in the insulated electric wire according to the embodiment of the present disclosure described above and was designated as Sample 1.

Further, the flat electric wire was used to prepare inverse flat electric wires of Samples 2 and 3 as models of the inverse flat portions. In this case, a force was applied from outside toward inside in a width direction of the flat shape in a region over 14 cm in a middle in an axial direction of the flat electric wire cut to 20 cm, thereby changing the width direction of the conductor by approximately 90° to form an inverse flat portion. The flatness ratio of the conductor in the inverse flat portion was set to 1.8 for Sample 2 and 2.8 for Sample 3 by changing a magnitude of the applied force. A greater force was applied for Sample 3 than for Sample 2. The force for forming the inverse flat portion was applied while an area including the inverse flat portion was heated, thereby causing the insulation coating to adhere closely to the conductor.

### Evaluation Methods

The distributions of the deformation ratios of the elemental wires were evaluated for the flat electric wire of Sample 1 and the inverse flat electric wires of Samples 2 and 3 prepared above. Here, each electric wire was embedded and fixed in acrylic resin and cut perpendicular to the axial direction to prepare a cross-sectional sample. Then, each cross-sectional sample was observed with a microscope to evaluate deformation of the elemental wires at each part of the cross-section. Specifically, the deformation ratios of the elemental wires in the first outer-peripheral region R1, the second outer-peripheral region R2, and the central region R3 were quantitatively evaluated using microscopic images of the cross-sections. For the evaluation, measurement was conducted on twelve elemental wires randomly selected among the elemental wires included in each region, and deformation ratio (D) of the elemental wire was estimated according to the above-described formula (1). Then, an average value of the deformation ratios of the elemental wires obtained in each region was recorded.

Further, flexibility of each of the insulated electric wires of Samples 1 to 3 was evaluated. The evaluation was carried out by a three-point bending test. Specifically, the insulated electric wire of each sample was supported by two cylindrical fulcrum jigs, and a cylindrical pressing jig was pressed into a midpoint between the fulcrums from the direction opposite to the supporting direction to measure a rebound load occurred to the insulated electric wire. Then, the maximum rebound load until the wire dropped between the fulcrums was recorded as the bending load. The smaller the bending load, the higher the flexibility of the insulated electric wire. In the measurement, a distance between the fulcrums was 120 mm, and the length of the insulated electric wire used as a sample was 200 mm. For the inverse flat electric wires of Samples 2 and 3, the inverse flat portions were arranged over the entire areas between the fulcrum jigs. The measurements were performed on all of Samples 1 to 3 with respect to bending in the width directions, and further, the measurements were performed on Sample 1 with respect to bending in the height direction.

### Evaluation Results

FIGS. 5A to 5C show cross-sectional photographs of Samples 1 to 3, respectively. Table 1 shows dimensions of the insulated electric wire as a whole and the conductor alone, as well as a thickness of the insulation covering at each part, measured from the cross-sectional photographs. As for the thickness of the insulation covering, the top, bottom, left, and right directions correspond to the directions in the cross-sectional photographs.

TABLE 1

| | | Sample 1 | Sample 2 | Sample 3 |
|---|---|---|---|---|
| | | Flat Electric | Inversel Flat | Inverse Flat |
| | | Wire | Electric Wire | Electric Wire |
| | | (Flatness | (Flatness | (Flatness |
| | | Ratio: 3) | Ratio: 1.8) | Ratio: 2.8) |
| Wire | Height | 11.7 | 14.3 | 11.7 |
| Dimension | Width | 28.8 | 26.4 | 32.5 |
| (mm) | | | | |
| Conductor | Height | 8.5 | 12.6 | 10.3 |
| Dimension | Width | 25.4 | 23.1 | 28.5 |
| (mm) | | | | |
| Thickness | Left | 1.7 | 1.0 | 0.56 |
| of Covering | Top | 1.5 | 1.4 | 1.8 |
| (mm) | Right | 1.4 | 0.66 | 0.85 |
| | Bottom | 1.4 | 1.0 | 2.0 |

As shown in FIGS. 5A to 5C and Table 1, for samples 2 and 3, the forces were applied from outside toward inside in the width directions of the flat shapes (the forces of left and right directions in the cross-sectional photographs). As a result, it was confirmed that the inverse flat portions in which the width directions of the flat shapes were changed by approximately 90° from that of Sample 1 were formed. This fact indicates that the insulated electric wire in which the flat portion and the inverse flat portion coexist can be produced by applying a force to a partial region of a raw flat electric wire to cause deformation. As seen from the cross-sectional photographs and values in the table, the insulation covering became thinner in the height direction of the inverse flat wire (left and right directions in the cross-sectional photographs) than that of the flat electric wire with the force being applied.

Next, the values of the deformation ratios (an average value of twelve elemental wires) of the elemental wires and the bending loads are presented in Table 2. The deformation ratios of the elemental wires being estimated for each of the first outer-peripheral region R1, the second outer-peripheral region R2, and the central region R3 in the cross-sectional photographs of FIGS. 5A to 5C, respectively, and the bending loads obtained by the three-point bending test.

TABLE 2

| | | Sample 1 | Sample 2 | Sample 3 |
|---|---|---|---|---|
| | | Flat Electric | Inverse Flat | Inverse Flat |
| | | Wire | Electric W | Electric W |
| | | (Flatness | (Flatness | (Flatness |
| | | Ratio: 3) | Ratio: 1.8) | Ratio: 2.8) |
| Average | First Outer- | 6 | 10 | 12 |
| Deforma- | Peripheral Regid | | | |
| tion Ratio | R1 | | | |
| of | Second Outer- | 17 | 16 | 19 |
| Elemental- | Peripheral Regid | | | |
| Wire | R2 | | | |
| (%) | Central Region | 19 | 17 | 16 |
| | R3 | | | |
| Bending | Height Direction | 71 | 140 | 102 |
| Load | Width Direction | 223 | — | — |
| (N) | | | | |

According to Table 2, in all of Samples 1 to 3, the deformation ratio of the elemental wires in the first outer-peripheral region R1 is lower than that in the second outer-peripheral region R2 and in the central region R3 among three regions R1 to R3. From this fact, it is confirmed that the lower deformation ratios of the elemental wires in the first outer-peripheral region R1 of the flat electric wire of Sample 1, corresponding to the outer portion in the width direction is also maintained in the inverse flat electric wires of Samples 2 and 3 which have undergone inverse flattening by the application of the forces. Furthermore, it is seen that no significant deformation of the elemental wires themselves occurs after inverse flattening. Compared to Sample 2, which has a lower flat ratio, Sample 3 was subjected to a larger force during the inverse flattening, resulting in a higher flat ratio and a slightly higher deformation ratio of the elemental wire in the first outer-peripheral region R1. The deformation ratios of the elemental wires in the second outer-peripheral region R2 and the central region R3 are almost unchanged among Samples 1 to 3.

Next, the value of the bending load in Table 2 was reviewed. In the flat electric wire of Sample 1, the bending load in the height direction is approximately one-third of the bending load in the width direction. This means that, the insulated electric wire has a flat shape, which increases its flexibility in the height direction. Next, in the inverse flat electric wires of Samples 2 and 3, the bending loads in the height direction are smaller than the bending loads in the width direction of Sample 1. In other words, the dimensions in the directions which was the width direction in Sample 1 (left and right direction in the cross-sectional photograph) was made smaller through the inverse flattening, and the direction was made to be the height direction, whereby flexibility was increased. This result indicates that if the inverse flat portion is formed in the flat electric wire, the direction in which the wire can be flexibly bent can be changed.

When the flatness ratio of the inverse flat electric wire is increased from 1.8 for Sample 2 to 2.8 for Sample 3, the bending load in the height direction becomes further reduced. Further, the bending load also became 120 N, which is an intermediate value, when the inverse flat electric wire with the flatness ratio being set to 2.4, which is an intermediate value between 1.8 and 2.8, was also measured in the bending load in the height direction. From these results, it is confirmed that, in the inverse flat electric wire, the higher the flatness ratio and the wider the shape, the greater the flexibility in the height direction. Furthermore, when the flat electric wire of Sample 1 and the inverse flat electric wire of Sample 3 were compared, which have an approximately same flatness ratio, the bending load of Sample 3 in the height direction, although reduced to less than half of the bending load in the width direction of Sample 1, is slightly larger than the bending load of Sample 1 in the height direction. This is considered to be due to the increased entanglement of the elemental wires or the increased adhesion between the conductor and the insulation covering, caused during a process of forming the inverse flat portion by applying the force.

Although the embodiments of the present disclosure have been described in detail above, the present invention is not limited to the above-described embodiments, and various modifications are possible without departing from the gist of the present invention.

### LIST OF REFERENCE SIGNS

1: insulated electric wire
11: conductor
12: elemental wire
13: insulation covering
2: flat portion
2A: first flat portion
2B: second flat portion
3: inverse flat portion
h: height of conductor in flat portion
h′: height of conductor in inverse flat portion
w: width of conductor in flat portion
w′: width of conductor in inverse flat portion
x: axial direction of insulated electric wire
y: flat direction (width direction of flat portion)
z: inverse flat direction (height direction of flat portion, width direction of inverse flat portion)
F: force
R1: first outer-peripheral region
R2: second outer-peripheral region
R3: central region

1. An insulated electric wire comprising:
a conductor comprising a plurality of elemental wires twisted together; and
an insulation covering that covers the conductor, wherein
the insulated electric wire comprises a flat portion and an inverse flat portion along an axial direction of the insulated electric wire, wherein each of the elemental wires composing the conductor and the insulation covering are continuous between the flat portion and the inverse flat portion,
in the flat portion, the conductor has a flat shape that is long in a flat direction in a cross-section perpendicular to the axial direction,
in the inverse flat portion, the conductor has a flat shape that is long in an inverse flat direction different from the flat direction in a cross-section perpendicular to the axial direction, and
in each of the cross-sections of both the flat portion and the inverse flat portion, portions facing an outer periphery of the conductor, comprise:
a first outer-peripheral region located in the flat direction with respect to the axial direction, and
a second outer-peripheral region located in a direction perpendicular to the flat direction with respect to the axial direction, and
the elemental wires in the first outer-peripheral region have deformation ratios deformed from a circular shape lower than the deformation ratios of the elemental wires in the second outer-peripheral region.

2. The insulated electric wire according to claim 1, wherein in the cross-sections of both the flat portion and the inverse flat portion, the elemental wires in the first outer-peripheral region have the deformation ratios deformed from a circular shape lower than that of the elemental wires in a central portion of the conductor.

3. The insulated electric wire according to claim 1, wherein the flat direction and the inverse flat direction differ by 10° or more.

4. The insulated electric wire according to claim 1, wherein the flat direction and the inverse flat direction differ by 45° or more.

5. The insulated electric wire according to claim 1, wherein in the cross-sections of both the flat portion and the inverse flat portion, the elemental wires in the first outer-peripheral region have the deformation ratios deformed from a circular shape of 70% or lower of those in the elemental wires in the second outer-peripheral region.

6. A wiring harness, comprising the insulated electric wire according to claim 1.

7. A method for producing an insulated electric wire, wherein the insulated electric wire according to claim 1 is produced by steps of:
preparing a raw flat electric wire comprising the conductor compressed into a flat shape, and an insulation covering that covers the conductor,
deforming the conductor into a flat shape that is long in a direction different from a direction in which the flat shape was long before application of the force by applying a force to the raw flat electric wire from an outside toward an inside in a width direction of the flat shape in a partial region along the axial direction, thereby forming the inverse flat portion, and
leaving a rest of the raw flat electric wire, where the inverse flat portion was not formed, as a flat portion, thereby producing the insulated electric wire.
